(19) United States
(12) Patent Application Publication
(10) Pub. No.: US 2008/0281823 A1
(43) Pub. Date: Nov. 13, 2008

(54) System and Method for Display of Chained Messages in a Single Email in Different Orders

(76) Inventors: Yen-Fu Chen, Austin, TX (US); John Hans Handy-Bosma, Cedar Park, TX (US); Keith Raymond Walker, Austin, TX (US)

Correspondence Address: IBM CORPORATION (AUS);c/o Rudolf O Siegesmund Yee & Associates, P.C., P.O. Box 802333, DALLAS, TX, 75380, US

(21) Appl. No.: 12/177,283

(22) Filed: Jul. 22, 2008

Related U.S. Application Data
(63) Continuation of application No. 11/032,850, filed on Jan. 11, 2005.

(51) Int. Cl. G06F 7/06; G06F 17/30

(52) U.S. Cl. 707/7; 707/E17.044

(57) ABSTRACT

Systems and methods for display of chained messages in a single email in different orders allow a user to specify sort criteria to determine the order of display of chained messages. The system includes a message finding program and a message sorting program. The message finding program identifies individual messages within an email and populates a message list with a unique identifier for each message and sorting data contained within each message. The message sorting program receives sorting criteria defined by a user via an email display and sorts the sorting data within the message list pursuant to the sorting criteria. After sorting the message list, the message sorting program provides the email display with the messages in order of their identifiers within the message list for display as a single email in their sorted order.

### CROSS-REFERENCE TO RELATED APPLICATION

This application is a continuation application of co-pending U.S. utility patent application entitled “System and Method for Display of Chained Messages in a Single Email in Different Orders”, filed on Jan. 11, 2005 and accorded Ser. No. 11/032,850, and claims priority therefrom.

### FIELD OF THE INVENTION

This invention is related to the field of electrical computers and digital processing systems in general, and specifically to processes used to display chained messages in a single email in different orders.

### BACKGROUND OF THE INVENTION

Currently, email clients such as MICROSOFT OUTLOOK and LOTUS NOTES enable a user to exchange electronic messages with other users through networked email servers. If a user wants to respond to a message, the user activates a “reply” command. In general, an email client responds to a “reply” command by creating a new message with the same subject line. Frequently the reply email contains the original message in addition to the reply text. Often, the original message is not deleted and many email clients copy the content of the original message into the reply message.

The parties may engage in an exchange based on the original email. Each new reply may contain the text of all the previous emails. As the number of prior emails increases, the parties may find it useful to sort and display the chained messages in different orders other than the traditional reverse chronological order.

Referring to FIG. 1, prior art email message 100 is shown with five messages between Dan and John that will be used to illustrate how chained messages are traditionally displayed. In sequence, first message 120 is the original message from Dan to John, second message 130 is John's reply to Dan, third message 140 is Dan's reply to John, fourth message 150 is John's reply to Dan, and fifth message 160 is Dan's reply to John. When fifth message 160 is sent, there will have been five separate message transmissions. The cumulative content can be seen by reference to FIG. 1.

Various conventions are employed in the prior art to aid users in differentiating between the most recent message 160 and prior messages 150, 140, 130, and 120. As is illustrated in FIG. 1, the chained messages are often separated by a demarcation 118 such as “---- Original Message ----” and may be indented through the use of one or more leading characters 120 such as “>” to denote the order of the chained messages, with older messages being preceded by more leading characters 120. A structured header 122 often precedes each chained message. The header 122 contains information regarding the sender 112, the recipient 110, the date/time 114 the message was sent, and the subject 116 of the message. Traditionally, the chained messages are displayed to the user in reverse chronological order based on date/time 114. However, as the number of chained messages increases, and particularly when new parties are provided with an email comprising several chained messages as their first introduction to the exchange, displaying the chained messages in a different order than reverse chronological can be helpful. Therefore, a need exists to allow a user to sort chained messages in a single email in a variety of orders based on user-defined criteria, and thereby facilitate user understanding of the content of the email.

U.S. patent application Ser. No. 10/897,230 (The '230 application) discloses a method and technique for duplicate email content detection and automatic doclink conversion. The '230 application is a method to analyze an email message to determine whether the message contains a unique section identification embedded in the email. If not, the invention assigns a unique section identification number, embeds the unique section identification in the message, and forwards the message to the recipient. If the message contains a unique section identification, then the section with the section identification will be extracted from the email message, stored in a repository, a pointer to the stored section will be embedded with the unique section identification to form a doclink, the remaining message will be assigned a unique section identification, embedded in the message, and the email will be forwarded with the new section and the doclink to the old section.

Although the '230 application disclosed sorting and displaying emails having a doclink using various single criteria, it did not contemplate sorting and displaying chained messages without duplicate content detection and using multiple user configurable criteria simultaneously. What is needed beyond the prior art is a method to display chained messages in a single email independent of a duplicate content detection system and in different orders employing multiple user-defined sort criteria simultaneously.

### SUMMARY OF THE INVENTION

The invention that meets the needs described above consists of a Message Finding Program (MFP) to identify chained messages in an email, a Message Sorting Program (MSP) to sort the chained messages according to user specifications, and a user interface that permits a user to define sorting criteria and view the sorted messages as a single email. The message finding program locates individual messages within a received email and assigns a unique identifier to each message. The MFP then locates sorting data within each individual message and stores it with the message's identifier in a message list. In response to receiving user input containing a first sort criteria and a second sort criteria, the MSP sorts the sorting data in the message list by the first sort criteria and then sorts the sorting data having the same first sort criteria by the second sort criteria. The MSP concludes by sending the messages in the order of their identifiers within the sorted message list to the UI for display to the user as a single email. The sorting data may be at least one of the group consisting of date/time, sender, recipient and subject. The sort criteria may each specify a sort order selected from the group consisting of ascending order in descending order. The MFP may execute in response to a user request to view the email. The invention may be a program product operable on a computer stored on a computer-usable medium.

### BRIEF DESCRIPTION OF DRAWINGS

The novel features believed characteristic of the invention are set forth in the appended claims. The. invention itself, however, as well as a preferred mode of use, further objectives and advantages thereof will best be understood by reference to the following detailed description of an illustrative embodiment when read in conjunction with the accompanying drawings, wherein:

FIG. 1 depicts a typical prior art email with a series of reply messages;

FIG. 2 depicts a computer network in which the invention may be employed;

FIG. 3 depicts a representative server computer in which the invention may reside;

FIG. 4 depicts a flow chart of the Message Finding Program (MFP) associated with the present invention;

FIG. 5 depicts a flow chart of the Message Sorting Program (MSP) associated with the present invention;

FIG. 6 is an illustration of an email display associated with the present invention; and

FIG. 7 depicts a message list associated with the present invention.

### DETAILED DESCRIPTION OF THE PREFERRED EMBODIMENT

A person of ordinary skill in the art will appreciate that the present invention may be implemented in a variety of software and hardware configurations. It is believed, however, that the invention is described best as a computer program that configures and enables one or more general-purpose computers to implement the novel aspects of the invention.

As used herein, “email” means an electronic mail message transmitted between user terminals over a computer network.

As used herein, “computer” means a machine having a processor, a memory, and an operating system, capable of interaction with a user or other computer, and shall include without limitation desktop computers, notebook computers, tablet computers, personal digital assistants (PDAs), servers, handheld computers, and similar devices.

As used herein, “chained messages” means two or more electronic mail messages originally transmitted between user terminals over a computer network as individual electronic mail messages that have been combined into a single email and transmitted between user terminals over a computer network.

As used herein, “memory” means the internal memory of a computer, including all storage devices internally accessible to a computer and externally accessible to the computer via a network.

As used herein, “repository” means a portion of a memory, or of a distributed memory, in which an email and an associated message list can be stored for later retrieval.

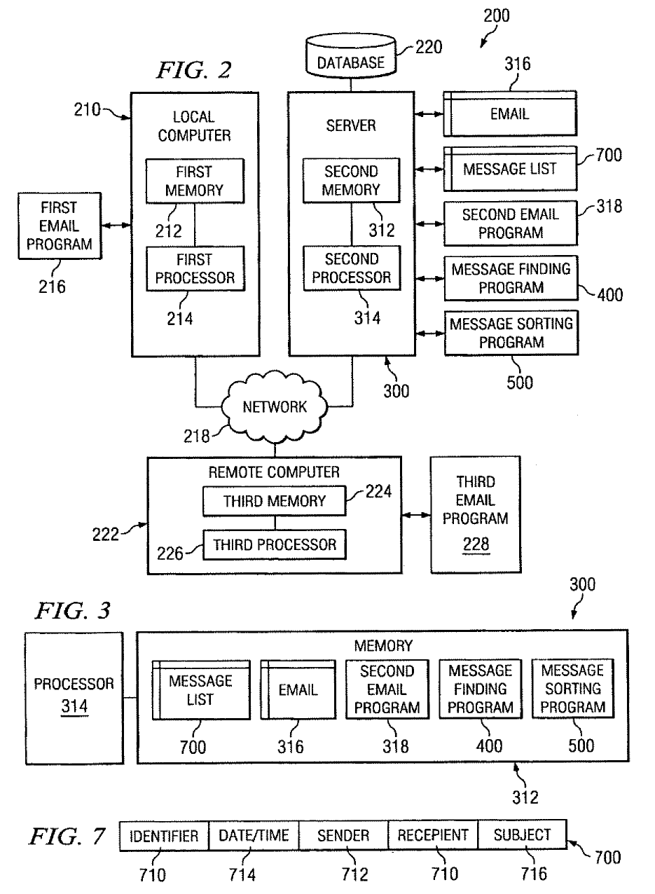

FIG. 2 is an illustration of computer network 200 associated with the present invention for transferring data. Computer network 200 comprises local computer 210 electrically coupled to network 218. In FIG. 2, local computer 210 is coupled electrically to remote computer 222 via network 218. Local computer 210 also is coupled electrically to server 300 with database 220 via network 218. Network 218 may be a simple local area network (LAN) or may be a larger wide area network (WAN), such as the Internet. While computer network 200 depicted in FIG. 2 is intended to represent a possible network architecture, it is not intended to represent an architectural limitation.

Local computer 210 has fast memory 212 and first processor 214 that run first email program 216. Remote computer 222 has third memory 224 and third processor 226 that run third email program 228. Server 300 has second memory 312 and second processor 314 that run second email program 318, message finding program 400, and message sorting program 500. Server 300 is linked to database 220 and stores email 316 and message list 700.

First memory 212, second memory 312, and third memory 224 may reside in server 300, database 220, or may be distributed in network 218 among one or more of server 300, local computer 210, or remote computer 222. Alternatively, first memory 212 may be combined with second memory 312 and third memory 224. First memory 212 is connected to network 218 by first processor 214. Second memory 312 is connected to network 218 by second processor 314. Third memory 224 is connected to network 218 by third processor 226.

The internal configuration of a computer, including connection and orientation of the processor, memory, and input/output devices, is well known in the art. The present invention is a methodology that can be embodied in a computer program. Referring to FIG. 3, server 300 stores message list 700, email 316, second email program 318, message fording program 400, and message sorting program 500 in third memory 224, where they are operable by third processor 226. Third memory 224 is only illustrative of memory within a computer and is not meant as a limitation.

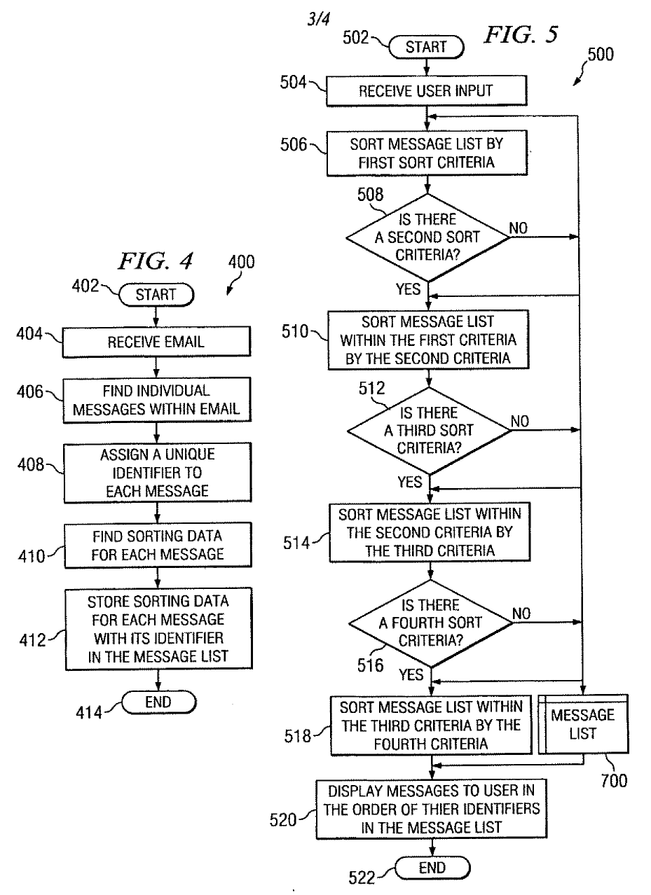

FIG. 4 depicts a flow chart of Message Finding Program (MFP) 400. MFP 400 starts (402) and receives email 316 (404). MFP 400 fords individual messages within email 316 (406) and assigns a unique identifier 710 to each message (408). MFP 400 then finds sorting data for each message within email 316. Sorting data can include date/time data, sender and recipient data, and subject data. After finding the sorting data, MFP 400 stores the sorting data for each message, along with the message's identifier, in message list 700 (412) prior to terminating (414). A variety of techniques familiar to person skilled in the art would be used to find individual messages within email 316.

FIG. 5 depicts a flow chart of Message Sorting Program (MSP) 500. MSP 500 starts (502) and receives user input containing sort criteria (504). MSP 500 proceeds to sort message list 700 by the first sort criteria (506). If there is not a second sort criteria, then MSP 500 displays the messages within email 316 in the order of the identifiers 710 in message list 700 (520) and terminates (522). If there is a second sort criteria, MSP 500 proceeds to sort the portions of the sorting data in message list 700 having the same first sort criteria by the second sort criteria.

MSP 500 then checks to see if the user specified a third sort criteria (514). If not, MSP 500 performs step 520 and terminates (522). If there is a third sort criteria, MSP 500 proceeds to sort portions of the sorting data in message list 700 having the same first sort criteria and second sort criteria by the third sort criteria.

Finally, MSP 500 then checks to see if the user specified a fourth sort criteria (516). If not, MSP 500 performs step 520 and terminates (522). If there is a fourth sort criteria, MSP 500 proceeds to sort the portions of the sorting data in message list 700 having the same first sort criteria, second sort criteria, and third sort criteria by the fourth sort criteria prior to performing step 520 and terminating (522). A variety of techniques known to persons skilled in the art would be used to sort the sorting data in the message list 700. Up to four sets of sort criteria is intended as a representation of possible applications of the present invention and is not meant as a limitation.

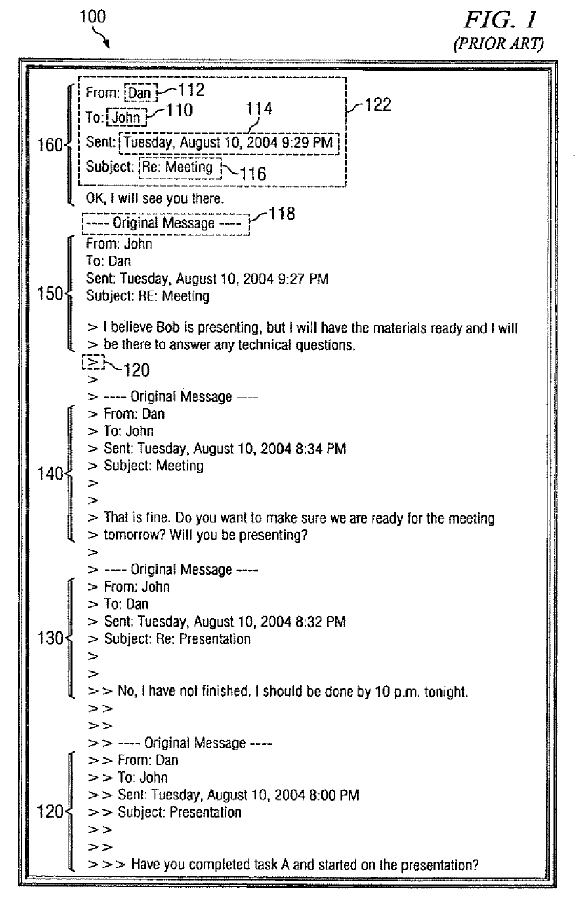

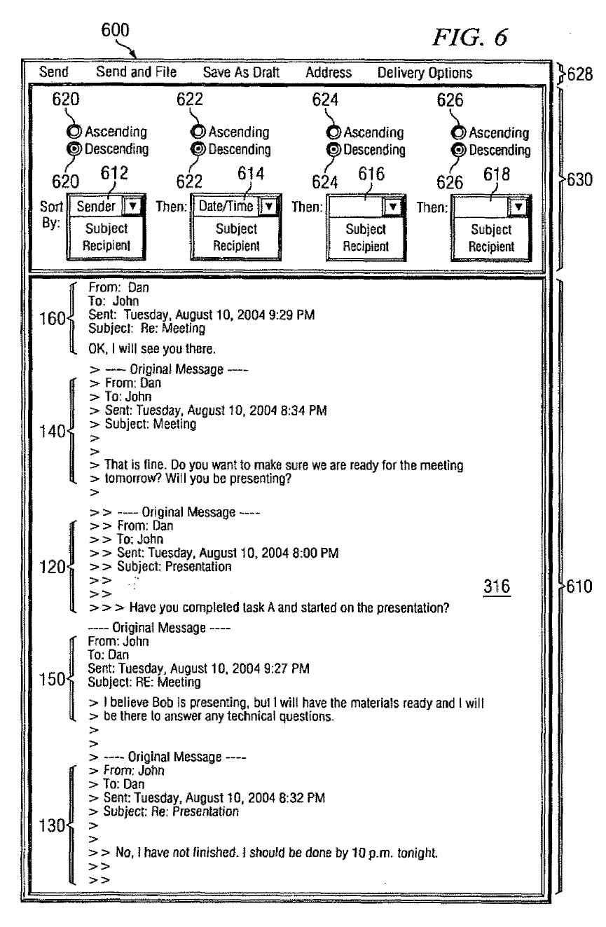

FIG. 6 depicts email display 600. Email display 600 has utility section 628 from which the user can select actions such as send, send and file, save as draft, address, and delivery options. Messages 160, 140, 120, 150, and 130 comprise email 316 and are displayed in email display area 610 in an order determined by sort controls 630. In the example, the user has selected a first sort criteria of sender and a second sort criteria of date/time using list boxes 612 and 614. As a result, messages 160, 140, 120, 150, and 130 are displayed sorted by those criteria rather than in the reverse chronological order depicted in FIG. 1. The user can use list boxes 616 and 618 to specify third and fourth sort criteria, respectively. In the current embodiment, the choices available within each of the list boxes 612, 614, 616, and 618 are dynamically pruned based upon the user's previous selections. Radio buttons 620, 622, 624, and 626 allow the user to select whether each of the sort criteria are applied in ascending order or descending order.

List boxes 612, 614, 616, and 618 and radio buttons 620, 622, 624, and 626 can be implemented using VB, C++, Java, or AWT/Swing. The features can be implemented as a plug-in to reduce the cost of a new email program and/or making users download and install a new email program.

FIG. 7 shows message list 700. Message list 700 is populated by MFP 400 with sorting data consisting of identifier 710, date/time 714, sender 712, recipient 710, and subject 716 from each of the messages found by MFP 400 within email 316. Once the user specifies sorting criteria using sort controls 630, MSP 500 sorts the sorting data according to the sorting criteria and provides the messages as a single email to email display 600 in the order of their sorted identifiers 710.

Persons skilled in the art will be aware of multiple methods by which a user can activate the sorting features of the present invention such as clicking on an icon, moving the cursor to a designated corner of the display, or passing the cursor over a control. Repeating the same action would then deactivate the sorting feature of the present invention.

Persons skilled in the art will be aware of multiple ways in which a user can implement the sorting features of the present invention. The sorting option may be enabled on either a server system or a client system. Since a server typically has more computing power than a client, it would be preferable to have the sorting performed by the server. A module may be added to the present invention to detect a user's sort choices and set the default sorts in accordance with the most frequently used choices. Additionally, the invention may be configured to automatically display email in default sequence for new users added in the middle of an email chain.

With respect to the above description, it is to be realized that the optimum dimensional relationships for the parts of the invention, to include variations in size, materials, shape, form, function, manner of operation, assembly, and use are deemed readily apparent and obvious to one of ordinary skill in the art. The present invention encompasses all equivalent relationships to those illustrated in the drawings and described in the specification. The novel spirit of the present invention is still embodied by reordering or deleting some of the steps contained in this disclosure. The spirit of the invention is not meant to be limited in any way except by proper construction of the following claims.

What is claimed is:

1. A method to display chained messages in a single email in different orders comprising:
(a) receiving an email;
(b) responsive to receiving an email finding individual messages within the email;
(c) responsive to finding an individual message, assigning a unique identifier to each message;
(d) responsive to finding an individual message, finding sorting data for each message;
(e) responsive to finding an individual message, storing the sorting data for each message with its identifier in a message list;
(f) receiving a first sort criteria and a second sort criteria from a user;
(g) responsive to receiving a first sort criteria and a second sort criteria from a user, sorting the sorting data in the message list by the first sort criteria and then sorting the sorting data having the same first sort criteria by the second sort criteria; and
(h) displaying the messages in the order of their identifiers within the message list to the user.

2. The method of claim 1, wherein the sorting data is at least one of the group consisting of date/time, sender, recipient, and subject.

3. The method of claim 1, wherein the first sort criteria and the second sort criteria each specify a sort order selected from the group consisting of ascending order and descending order.

4. The method of claim 1, wherein step (f) is replaced with receiving a first sort criteria, a second sort criteria, and a third sort criteria from a user and step (g) is replaced with responsive to receiving a first sort criteria, a second sort criteria, and a third sort criteria from a user, sorting the sorting data in the message list by the first sort criteria, then sorting the sorting data having the same first sort criteria by the second sort criteria, and then sorting the sorting data having the same first sort criteria and second sort criteria by the third sort criteria.

5. The method of claim 4, wherein the first sort criteria, the second sort criteria, and the third sort criteria each specify a sort order selected from the group consisting of ascending order and descending order.

6. The method of claim 1, wherein step (f) is replaced with receiving a first sort criteria, a second sort criteria, a third sort criteria, and a fourth sort criteria from a user and step (g) is replaced with responsive to receiving a first sort criteria, a second sort criteria, a third sort criteria, and a fourth sort criteria from a user, sorting the sorting data in the message list by the first sort criteria, then sorting the sorting data having the same first sort criteria by the second sort criteria, then sorting the sorting data having the same first sort criteria and second sort criteria by the third sort criteria, then sorting the sorting data having the same first sort criteria, second sort criteria, and third sort criteria by the fourth sort criteria.

7. The method of claim 6, wherein the first sort criteria, the second sort criteria, the third sort criteria, and the fourth sort criteria each specify a sort order selected from the group consisting of ascending order and descending order.

8. The method of claim 1, wherein steps (b)-(e) may take place in response to a user request to view the email.

9. The method of claim 1, wherein steps (b)-(e) are performed automatically by a computer.

10. An apparatus for displaying chained messages in a single email in different orders comprising:
a network connecting a first computer having a first computer memory, a second computer having a second computer memory, and a third computer having a third computer memory;
a repository connected to the second computer;
an email transmitted from the third computer to the first computer through the second computer;
a message finding program in the second computer memory instructing the second computer to:
(a) find individual messages within the email;
(b) responsive to finding an individual message, assigning a unique identifier to each message;
(c) responsive to finding an individual message, finding sorting data for each message;
(d) responsive to finding an individual message, storing the sorting data for each message with its identifier in a message list; and
a message finding program in the second computer memory instructing the second computer to:
(e) sort the sorting data in the message list by a first sort criteria and then sorting the sorting data having the same first sort criteria by a second sort criteria responsive to receiving the first sort criteria and the second sort criteria from a user; and
(f) sending the messages in the order of their identifiers within the message list to the first computer for display to the user in that order as a single sorted email.

11. The apparatus of claim 10, further comprising a program in the first computer memory for receiving the first sort criteria and the second sort criteria from the user and displaying the sorted email to the user.

12. The apparatus of claim 10, wherein the sorting data is at least one of the group consisting of date/time, sender, recipient, and subject.

13. The apparatus of claim 11, wherein the program in the first computer memory for receiving the first sort criteria and the second sort criteria from the user and displaying the sorted email to the user also receives a sort order selected from the group consisting of ascending order and descending order for each sort criteria.

14. The apparatus of claim 10, wherein step (e) is replaced with sort the sorting data in the message list by a first sort criteria, then sorting the sorting data having the same first sort criteria by a second sort criteria, and then sorting the sorting data having the same first sort criteria and second sort criteria by a third sort criteria responsive to receiving the first sort criteria, the second sort criteria, and the third sort criteria from a user.

15. The apparatus of claim 14, further comprising a program in the first computer memory for receiving the first sort criteria, the second sort criteria, and the third sort criteria from the user and displaying the sorted email to the user, wherein the program in the first computer memory for receiving the first sort criteria, the second sort criteria, and the third sort criteria also receives a sort order selected from the group consisting of ascending order and descending order for each sort criteria.

16. The apparatus of claim 10, wherein step (e) is replaced with sort the sorting data in the message list by a first sort criteria, then sorting the sorting data having the same first sort criteria by a second sort criteria, then sorting the sorting data having the same first sort criteria and second sort criteria by a third sort criteria, and then sorting the sorting data having the same first sort criteria, second sort criteria, and third sort criteria by a fourth sort criteria responsive to receiving the first sort criteria, the second sort criteria, the third sort criteria, and the fourth sort criteria from a user.

17. The apparatus of claim 16, further comprising a program in the first computer memory for receiving the first sort criteria, the second sort criteria, the third sort criteria, and the fourth criteria from the user and displaying the sorted email to the user, wherein the program in the first computer memory for receiving the first sort criteria, the second sort criteria, the third sort criteria, and the fourth sort criteria also receives a sort order selected from the group consisting of ascending order and descending order for each sort criteria.

18. The apparatus of claim 10, wherein steps (a)-(d) may take place in response to a user request made to the program in the first computer memory for receiving the first sort criteria and the second sort criteria from the user and displaying the sorted email to the user.

19. A program product operable on a computer comprising:
a computer-usable medium;
wherein the computer usable medium comprises instructions for a computer to perform steps comprising:
(a) receiving an email;
(b) responsive to receiving an email, finding individual messages within the email;
(c) responsive to finding an individual message, assigning a unique identifier to each message;
(d) responsive to fording an individual message, finding sorting data for each message;
(e) responsive to finding an individual message, storing the sorting data for each message with its identifier in a message list;
(f) receiving a first sort criteria and a second sort criteria from a user;
(g) responsive to receiving a first sort criteria and a second sort criteria from a user, sorting the sorting data in the message list by the first sort criteria and then sorting the sorting data having the same first sort criteria by the second sort criteria; and
(h) displaying the messages in the order of their identifiers within the message list to the user.

20. The program product of claim 19, wherein the sorting data is at least one of the group consisting of date/time, sender, recipient, and subject.

21. The program product of claim 19, wherein the first sort criteria and the second sort criteria each specify a sort order selected from the group consisting of ascending order and descending order.

22. The program product of claim 19, wherein step (f) is replaced with receiving a first sort criteria, a second sort criteria, and a third sort criteria from a user and step (g) is replaced with responsive to receiving a first sort criteria, a second sort criteria, and a third sort criteria from a user, sorting the sorting data in the message list by the first sort criteria, then sorting the sorting data having the same first sort criteria by the second sort criteria, and then sorting the sorting data having the same first sort criteria and second sort criteria by the third sort criteria.

23. The program product of claim 22, wherein the first sort criteria, the second sort criteria, and the third sort criteria each specify a sort order selected from the group consisting of ascending order and descending order.

24. The program product of claim 19, wherein step (f) is replaced with receiving a first sort criteria, a second sort criteria, a third sort criteria, and a fourth sort criteria from a user and step (g) is replaced with responsive to receiving a first sort criteria, a second sort criteria, a third sort criteria, and a fourth sort criteria from a user, sorting the sorting data in the message list by the first sort criteria, then sorting the sorting data having the same first sort criteria by the second sort criteria, then sorting the sorting data having the same first sort criteria and second sort criteria by the third sort criteria, then sorting the sorting data having the same first sort criteria, second sort criteria, and third sort criteria by the fourth sort criteria.

25. The program product of claim 24, wherein the first sort criteria, the second sort criteria, the third sort criteria, and the fourth sort criteria each specify a sort order selected from the group consisting of ascending order and descending order.

26. The program product of claim 19, wherein steps (b)-(e) may take place in response to a user request to view the email.
